(19) United States
(12) Patent Application Publication
(10) Pub. No.: US 2013/0282164 A1
(43) Pub. Date: Oct. 24, 2013

(54) AUTOMATED RESTAURANT BEVERAGE DEVICE AND METHOD

(71) Applicant: Balagru K. Veloo, Gurnee, IL (US)

(72) Inventor: Balagru K. Veloo, Gurnee, IL (US)

(21) Appl. No.: 13/452,388

(22) Filed: Apr. 20, 2012

(51) Int. Cl. B67D 1/00

(52) U.S. Cl. CPC B67D 1/00
USPC 700/216; 700/218; 700/228; 198/750.1; 198/617

(57) ABSTRACT

Disclosed is a device and method for automated beverage dispensing, for staging beverages, and a cup carrier. Based on beverage orders, a cup picker having a telescoping mast picks a cup and places it on a cup carrier typically having a plurality of slots in its base. The cup carrier moves the cup to an ice dispenser, to a beverage dispenser, and typically to one of a couple transfer locations. From the transfer location, the cup is moved down a lane to a staging position. The identity of staged beverages is displayed on a human-readable display.

### FIELD OF THE INVENTION

The present invention relates to devices and methods for the automated dispensing and staging of beverages. More particularly, it relates to automated devices for dispensing and/or staging single-size servings of beverages from different order locations into containers and staging the containers and related methods of use thereof.

### BACKGROUND OF THE INVENTION

Restaurants in general and quick-service restaurants in particular serve large numbers of individual portion size beverages to customers. Often, the beverage is composed of ice and a soft drink. Typically, at quick-service restaurants, such single portion size beverages are served in single-use cups, that are generally cylindrical in shape. A large percentage of customer orders include more than one beverage and numerous customer orders are placed in rapid succession at a single restaurant. It is important that the customers receive the proper type and size beverage conforming to the order. Furthermore, it is important to have a system that is easy for restaurant workers to use for efficient operation, and fatigue reduction.

Consequently, a need exists for an automated beverage dispenser that can automatically dispense beverages into cups in response to orders and that is able to stage the beverages and keep track of which beverage or beverages are to be used to fill a particular order. A need also exists for an automated beverage dispensing and staging device that can receive orders from one or more POS registers and stage a plurality of single-size servings of the beverages in suitable containers, such as single-use cups, for example, to permit ready retrieval of the proper beverages to fill a particular order.

Quick-service restaurants also need to offer single-serve beverages in generally cylindrical single-use cups of different sizes, for example, such as from two, three, and up to six or even more cup sizes, and typically in a cup volume size range of from about 8 ounces or less to about 32 ounces or more. Such a range of cup sizes typically has significantly different cross-sectional diameters. A need therefore exists for an automated beverage dispenser that automatically selects a container or cup that corresponds to the ordered beverage size from a wide variety of cup sizes, then automatically dispenses the proper quantity of ice and the type and amount of beverage into the selected container or cup, for subsequent delivery to a customer.

### BRIEF SUMMARY OF THE INVENTION

In accordance with the present invention, an automated beverage dispensing device is provided. In one embodiment, the automated beverage dispensing device includes a beverage cup storage device for storing a plurality of beverage cups. Typically, it is contemplated that the beverage cup storage device will store cups in individual stacks of cups with a separate stack for each cup size. It is contemplated that a plurality of different size cups will be employed, typically ranging from two to six or more different sizes. Thus, there will be two to six or more stacks of cups stored in the beverage cup storage device. Cups can be stored in a desired array either linear or nonlinear, as desired. In one aspect of the invention, the beverage cup storage device is capable of storing cups in the size ranges of from about 6 or 8 ounces up to about 32 ounces or more. Typically, the type of cup that will be used is a single-use disposable beverage cup that is generally cylindrical in shape, typically having a slightly increasing cross-section that is circular and increases in diameter from cup bottom to cup top.

The automated beverage dispensing device in accordance with the invention has an ice dispensing location and a beverage dispensing location. Typically, the automated beverage dispensing device may include an ice storage bin with an ice dispensing device that dispenses ice at the ice dispensing location, the ice dispenser being configured to dispense ice into a single beverage cup at that location. The automated beverage dispensing device typically also includes a beverage delivery system which can be of conventional type to dispense one or more of a desired beverage at the beverage dispensing location. Typically, the beverage delivery system will be intended for dispensing soft drinks, but it is to be understood that any type of beverage can be dispensed in accordance with the invention.

In one embodiment, the automated beverage dispensing device also includes a cup picker device for picking a beverage cup from the cup storage device. The cup picker is controlled by an electronic interface or control system that operates the cup picker to move it to pick a desired size beverage cup for a particular order from the cup storage device. The cup picker then removes the desired cup size from the stored stack of beverage cups and moves it and deposits it at a cup transport. Typically, in operation of the automated beverage dispensing device the electronic interface or control system is configured so as to be able to receive a beverage order from a point-of-sale device electronically. That order can include various information on the beverage and the order, including the order number, so that the beverage can be served with the remainder of the food order, the beverage size and beverage type, including, for example, whether ice is desired or not with the beverage. That data is transferred to the automated beverage dispensing device and is electronically stored in the automated beverage dispensing device for display on a human-readable user interface forming part of the electronic interface of the automated beverage dispensing device.

The automated beverage dispensing device in one embodiment also includes a cup transport that is movable along a pathway from a receiving position for receiving the beverage cup from the cup picker and for moving a single cup in an upstanding orientation to the ice dispensing location, the beverage dispensing location and then to one or more transfer positions. Typically, it is contemplated that ice is first dispensed into the beverage cup followed by the beverage while the machine could be configured so that the beverage is dispensed first, should that be desired.

The automated beverage dispensing device typically further includes an automated beverage staging device having at least one staging lane. Each staging lane is associated with one of the transfer positions for staging completed beverages in cups. Each staging lane extends generally horizontally away from the associated one of the transfer positions of the cup transport pathway and each staging lane has a plurality of individual cup staging positions for permitting the staging device to stage that plurality of beverages in the staging lane. It is contemplated that each staging lane has a beverage cup mover for receiving a beverage cup from the cup transport at the associated one of the transfer positions of the cup transport pathway. The beverage cup mover of a particular staging lane is for moving the beverage cup from the cup transport to one of the staging positions of the staging lane with which the cup mover is associated. The cup mover is controlled by the electronic interface or control system which further includes suitable sensors for determining the presence or absence of a cup being staged in the staging lane at a particular location.

The automated beverage dispensing device typically will include an electronic interface that includes a human-readable display. The electronic interface is capable is identifying information on staged beverages. That information can be composed of both information that is received by the automated beverage dispensing device such as from a POS device, from information obtained by sensors, from information obtained by a machine vision system and from information that a human user or other source may input to the automated beverage dispensing device. The electronic interface is capable of identifying information on staged beverages and displaying the information on the human-readable display, the information typically including their staging positions and displaying the information on the display device. The order number of a particular beverage may also be displayed to enable the person assembling a food order to readily identify and remove the appropriate beverage or beverages to complete a particular food order. This is very advantageous in the operation of a quick-service restaurant as it ensures that the proper beverage is included with the proper order. It also is less stressful for the workers in the restaurant to properly fill beverage orders. The electronic interface is capable of indicating when a beverage cup is in the ice dispensing and beverage dispensing positions on the human-readable display and the identity of the beverage to be or being dispensed and the electronic interface device may include a machine vision device or other sensors to obtain information on the location of the staged beverages. The electronic interface can also be capable of identifying an order number for each of the staged beverages and displaying that information on the human-readable display in accordance with one embodiment. Typically, the order information will be provided to the automated beverage dispensing device from a POS device, alternatively other sources may provide the order number including a human operator input, for example. Similarly, the electronic interface in one embodiment is capable of identifying the type of beverage to be dispensed and displaying that information on the human-readable display, the information being obtained in a similar manner.

In accordance with another aspect of the invention, the cup picking device may comprise at least one suction cup connected to a vacuum source. The picker operates by placing the suction cup onto the side of a beverage cup. The suction is activated by a vacuum source causing the suction cup to attach to the outer sidewall of the beverage cup at which time the suction cup is moved to similarly move the beverage cup from the stack of stored beverage cups and thereafter the picker places the removed beverage cup in the cup transport. A vacuum sensor can be utilized to detect whether the suction cup has adhered to the beverage cup.

In accordance with one aspect of the invention, the cup transport comprises a cup carrier having an open top and at least partially closed bottom having at least one or more elongated slots, the elongated slot or slots being substantially parallel to the longitudinal direction of the cup carrier.

In accordance with another aspect of the invention, an automated beverage staging device is provided. The automated beverage staging device includes at least one staging lane, the at least one staging lane having a longitudinal direction and a plurality of individual cup staging positions. This permits the staging device to stage a plurality of ready-to-serve beverages, each contained in a desired type of beverage containing cup. In one embodiment of the staging device, the staging device comprises three substantially linear staging lanes, each lane capable of staging at least three beverage cups of the type stored in the cup storage device, for example. In one embodiment, the automated beverage staging device includes a beverage cup carrier mounted to a carriage for moving a beverage cup to the staging lane and a cup mover that is movable along the lane in the longitudinal direction for receiving a beverage cup from the cup carrier and for moving the beverage cup from the cup carrier to one of the staging positions of the staging lane. Typically, the cup carrier has an open top and an at least partially closed bottom having at least one elongated slot, the at least one elongated slot being at least generally parallel to the longitudinal direction of the staging lane. In one embodiment, the cup mover has a mover platform that has at least one elongated raised land capable of fitting within the at least one elongated slot. In another embodiment, a plurality of lands and slots are provided in the mover platform and the partially closed bottom of the cup carrier. The lane of the beverage staging device typically has a lane platform having at least one elongated slot within which the at least one elongated raised land is capable of fitting. The beverage staging device typically includes an elevator for raising and lowering the at least one raised land through the top of the at least one slot of the staging lane and the top of the at least one slot of the cup mover. The staging device may further include a sensor for each of the staging positions for detecting the presence or absence of a beverage cup at each staging position. The automated beverage staging device may further include an electronic interface or control system that includes a human-readable display device, the electronic interface being capable of identifying information on staged beverages and their staging positions and displaying the information on a human-readable display device. The electronic interface may further include a machine vision device that is capable of obtaining information on the location of staged beverages in the staging device. The machine vision and cup staging sensors can also be configured to detect cups being picked from cup storage, filled, open staging areas that have a cup manually placed in the staging area and to identify open staging positions.

In accordance with another aspect of the invention, an automated method of dispensing and staging beverages is provided. The automated method includes in one embodiment using the automated beverage dispensing device of the type as previously described. A plurality of cups are stored in the cup storage device, one of the plurality of cups is picked from the cup storage device with the cup picker in response to an order received from an input made to the automated beverage dispensing device, which may come from a POS device, another device or from a human operator input. The picker picks the desired cup size and places the picked cup on the cup carrier. Thereafter, the cup is transported by the cup transport to the ice or beverage dispensing position as required by a particular order (i.e., ice or no ice). Thereafter, ice is dispensed into the cup (if part of the beverage order) and then beverage is dispensed into the cup. It is to be understood that the sequence of dispensing ice and then beverage can be reversed in accordance with the invention. After the dispensing into the cup is completed, the finished beverage in the cup is transported by the cup carrier to a transfer position. From the transfer position, the beverage-containing cup is moved with the cup mover from the transfer position and along a staging lane having a plurality of staging positions to one of the staging positions where the beverage-containing cup is staged. The method may further include staging a second beverage at a second staging position in the staging lane as well as a third beverage-containing cup in a third staging position. The method may further include detecting the removal of a beverage-containing cup from one of the staging positions and moving another beverage-containing cup to the vacated staging position. Transporting the beverage-containing cup to a staging position includes aligning a plurality of slots in the cup transport with a plurality of slots in the staging lane in one embodiment. Moving the beverage-containing cup along the lane in one embodiment comprises moving the beverage-containing cup by a cup mover having at least one raised land and lifting the beverage-containing cup off of the cup carrier by raising the raised land through the at least one slot in the cup carrier.

The method in accordance with the invention may further include displaying information on the identity of beverages located at the plurality of staging positions by the electronic interface or control system on the human-readable display. Also, the order number and other desired information may be displayed on the human-readable display.

In accordance with another aspect of the invention, an automated method of staging beverages is provided. The method includes providing at least one staging lane where the at least one staging lane has a longitudinal direction and a plurality of beverage cup staging positions. The method further includes moving a beverage cup on a carrier mounted to a carriage to the lane and moving the beverage cup along the lane in the longitudinal direction from the carrier to one of the staging positions of the staging lane and staging the beverage cup at that staging position. The method may further include staging a second beverage cup at a second staging position of the staging lane. In one embodiment, the method further includes detecting the removal of a beverage cup that is staged at one of the staging positions and deleting the presence of that cup from being displayed on the human-readable display. The method of staging may further include staging another beverage cup at the vacated staging position. In accordance with the method, moving the beverage cup on the carrier may comprise aligning at least one slot in the carrier with at least one slot in the lane. Similarly, moving the beverage cup along the lane may comprise moving the beverage cup by a beverage cup mover having the at least one raised land and lifting the beverage cup off the beverage cup carrier by raising the raised land through the slot in the beverage cup carrier. Finally, the method may further include displaying information on the identity of beverages in the plurality of staging positions with the electronic interface or control system on a human-readable display.

In accordance with another aspect of the invention, a novel beverage cup carrier is provided. The novel beverage cup carrier in accordance with the invention includes an open top and an at least partially closed bottom having at least one elongated slot. The beverage cup carrier may have an open side and the at least one elongated slot extends to the open side of the cup carrier. The beverage cup carrier may further comprise a side opposite the open side having an opening at its base, the opening spanning across the at least one elongated slot. The beverage cup carrier may further include third and fourth sides substantially parallel to the at least one elongated slot. The at least one elongated slot may comprise a plurality of substantially parallel elongated slots.

In accordance with another aspect of the invention, a beverage cup moving device is provided. The beverage cup moving device includes a carriage and a beverage cup carrier mounted to the carriage that comprises an open top and at least a partially enclosed bottom having at least one elongated slot. The beverage cup moving device may further comprise a carrier having an open side with the at least one elongated slot extending to the open side. The carrier may further comprise a side opposite the open side, the side having an opening at the base and the opening spanning across at least the one elongated slot.

In accordance with another aspect of the invention, a method of moving a beverage cup containing a beverage is provided. The method includes providing the beverage cup carrier comprising an open top and at least a partially closed bottom having at least one elongated slot and moving a beverage cup containing a beverage in the cup carrier and removing the beverage cup from the cup carrier by raising a land through the elongated slot to lift the beverage cup off of the cup carrier.

### BRIEF DESCRIPTION OF THE DRAWINGS

FIG. 1 is a perspective view of an automated beverage dispensing device in accordance with the invention;

FIG. 2 is a left side elevation view of the automated beverage dispenser of FIG. 1;

FIG. 3 is a front elevation view of the automated beverage dispenser of FIG. 1;

FIG. 4 is a side elevation view showing the cup picking device of the automated beverage dispenser of FIG. 1;

FIG. 5 is a side elevation view showing the cup picking device of the automated beverage dispenser of FIG. 1 removing a selected cup from cup storage;

FIG. 6 is a side elevation view showing the cup picking device of the automated beverage dispenser of FIG. 1 having removed a cup from cup storage;

FIG. 7 is a side elevation view showing the cup picking device of the automated beverage dispenser of FIG. 1 moving a cup towards the cup transport fixture;

FIG. 8 is a side elevation view showing the cup picking device of the automated beverage dispenser of FIG. 1 placing a cup on the cup transport fixture;

FIG. 9 is a perspective view of a cup transport fixture in accordance with the invention;

FIG. 10 is a perspective view of a portion of the staging device forming part of the automated beverage dispenser of FIG. 1 with a shroud removed;

FIG. 11 is a top plan view of the staging device and cup transport device forming part of the automated beverage dispenser of FIG. 1;

FIG. 12 is a perspective view of a portion of the cup staging device and cup transport device forming part of the automated beverage dispenser of FIG. 1;

FIG. 13 shows a user interface device forming part of the automated beverage dispenser of FIG. 1 displaying information;

FIG. 14 shows the user interface device forming part of the automated beverage dispenser of FIG. 1 displaying order information; and

FIG. 15 is a schematic view showing a typical use of the automated beverage dispenser of FIG. 1 in a quick-service restaurant environment.

### DETAILED DESCRIPTION OF THE INVENTION

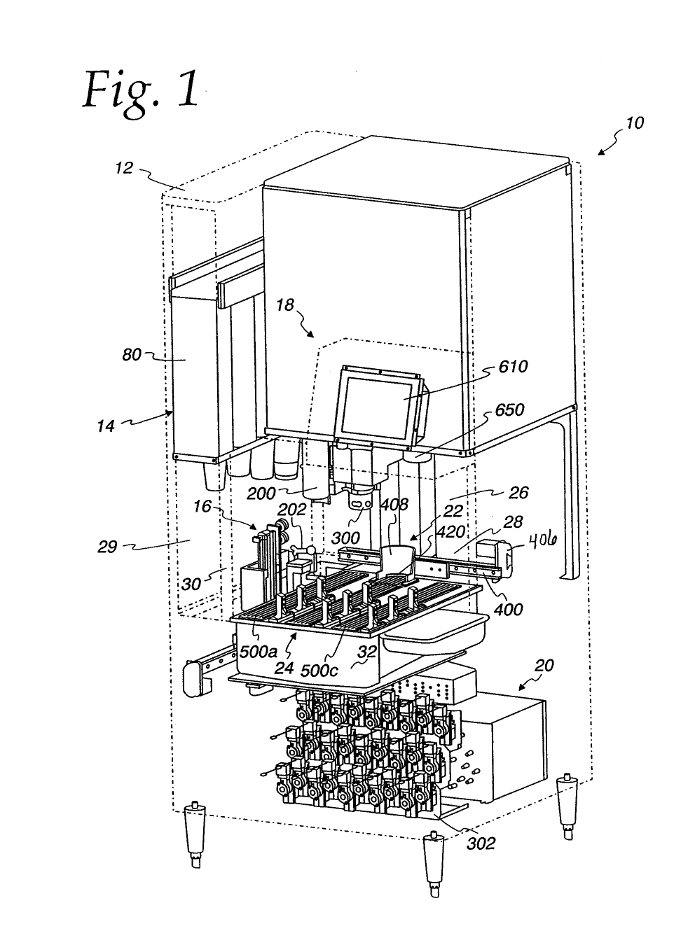

Referring to the figures generally and in particular to FIG. 1, there is illustrated an automated beverage dispenser and in accordance with the invention, automated beverage dispenser 10 includes a housing 12, a cup storage device 14, a cup picking system 16, an ice storage and dispensing system 18, a beverage delivery and dispensing system 20, a cup transport system 22, a drink staging system 24, and a control system 26 of dispenser 10.

Housing 12 is shown in FIGS. 1 and 3 partially removed to facilitate illustration of the internal components of automated beverage dispenser 10. Housing 12 is constructed of a suitable material, which may be stainless steel or other suitable material. Housing 12 has an opening 28 for dispensing and staging beverages which permits ready access to and removal of dispensed beverages by a person. Opening 28 may be separated from a space 29 between cup storage device 14 and cup picking system 16 by a partition 30, such as a clear glass, polycarbonate or other partition. Below opening 28 is a basin 32 for containing spills having basin sidewalls 34. Basin 32 may have a drain which discharges to a floor drain, for example.

Cup storage device 14 can be any suitable device, typically a bottom-discharging device for storing cups, although a top or side discharging device could be used. Device 14 is illustrated as providing storage for 6 different cup sizes ranging in size from small (about 8 ounces) to extra-large (about 32 ounces). Cup storage device 14 has a magazine 80 having one or more (typically 5 or 6) elongated storage tubes 82 for holding cups C. Tubes 82 each have a cylindrical internal storage volume for holding cups C in a nested configuration, a top inlet 86 and a bottom outlet 88. Tubes 82 are designed so that a cup C is held by its top in a ready position and the bottom of cup C extends beyond the bottom of tube 82 through outlet 88. When a cup C in the ready position is removed, a cup nested within cup C falls by gravity or is entrained by the removal of cup C into the ready position. Cups C can be of any suitable construction and material including plastic (expanded as in Styrofoam or non-expanded), paper, waxed paper and combinations thereof.

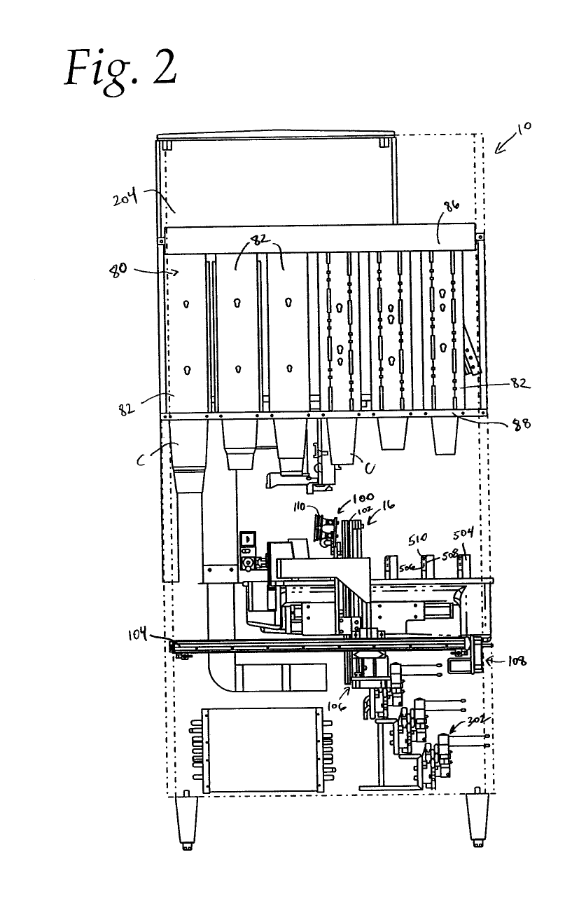

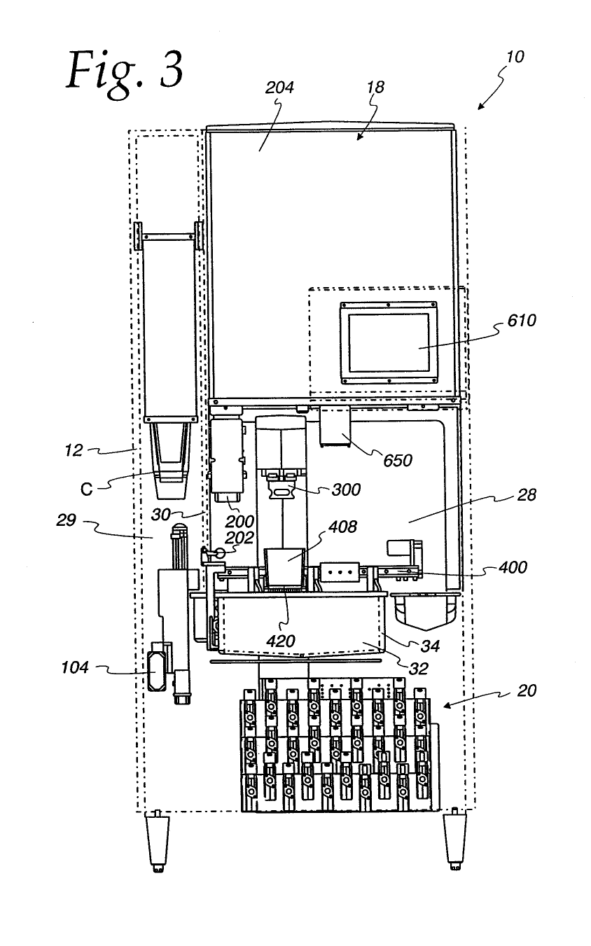

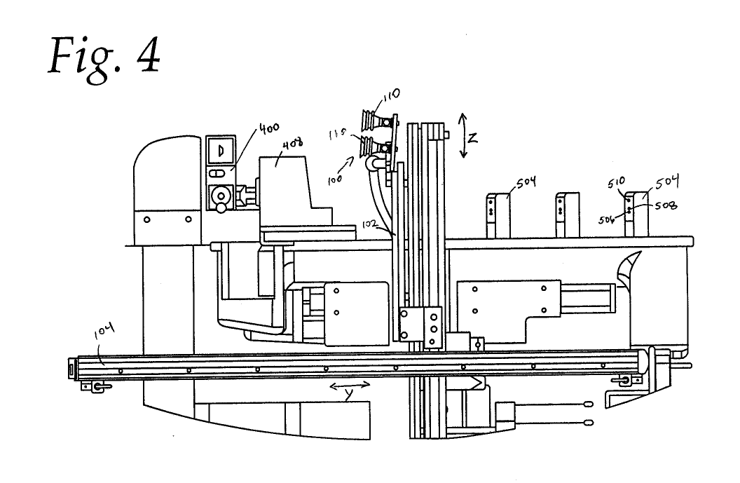

Referring to FIGS. 1-8, cup-picking system 16 is composed of a cup-picking head 100, a telescoping cup-picking mast 102 mounted for movement on a cup-picking carriage 104 in a direction Y, which is substantially horizontal. Mast 102 may extend and retract under the control of a linear actuator 106 in a direction Z, which is substantially vertical. Carriage 104 is driven by a drive mechanism 108 which advantageously may be a continuous loop drive belt, a linear actuator, or other suitable carriage drive mechanism. Drive mechanism 108 is capable of moving cup-picking head 100 laterally in a direction Y. Preferably, tubes 82 are aligned with drive mechanism 108. Cup-picking head 100 has at least one and preferably two suction cups 110. Preferably, suction cups 110 are substantially vertically aligned and offset horizontally to align both suction cups 110 with the exterior of a cup C. Suction cups 110 are connected by a vacuum line to a vacuum source. The vacuum line has a vacuum sensor near suction cups 110 to detect an increase in vacuum when suction cups 110 are adhered to cup C. Any suitable cup picking device can be used in accordance with one aspect of the invention.

Ice storage and dispensing system 18 has an ice nozzle 200, an ice-receiving position sensor 202, ice storage 204, and an ice dispenser. Nozzle 200 directs ice into a cup C below the nozzle. Ice-receiving position sensor 202 detects the presence of a cup C in the ice-receiving position below nozzle 200. Ice-receiving position sensor 202 communicates with the control system 26 for controlling the dispense of ice by the ice storage and dispensing system 18. Ice-receiving position sensor 202 can be any suitable sensor such as an optical or tactile sensor. The tactile sensor may include a wire in the form of a rectangle or a sideways W. In addition or alternatively, machine vision (subsequently discussed in greater detail) may be used to detect cup C in the ice-receiving position. Ice storage 204 can be any suitable ice storage known in the art. Ice storage 204 may be insulated, may include a freezer, and may include an ice maker. Ice dispenser can be any suitable ice dispenser known in the art. Preferably, the ice dispenser is capable of dispensing different amounts of ice depending on the size of cup C to be filled. Control system 26 may communicate to the ice dispenser the amount of ice to be dispensed or if no ice is to be dispensed.

Beverage delivery and dispensing system 20 is conventional as is well known in the art and may dispense pre- and post-mix beverages. Beverage delivery and dispensing system 20 may be connected to a carbonated water supply, a source of still water, a source of food-grade carbon dioxide, and various sources of beverage syrup typically of different flavors. Beverage delivery and dispensing system 20 may have a beverage dispensing nozzle 300 and a manifold 302. Nozzle 300 may be any suitable nozzle for mixing and dispensing post-mix beverages if post-mix dispensing is desired. Manifold 302 may be any suitable manifold for providing beverage syrups appropriate for a beverage order to nozzle 300.

Cup transport system 22 includes a carriage 400, a platform 402, extension 404 and a drive mechanism 406. Carriage 400 may be attached to the backwall of opening 28 of the automated beverage dispenser 10. Carriage 400 may include a bearings slide. Platform 402 is mounted to an extension 404 which is movably mounted or carried by carriage 400. Extension 404 permits platform 402 to travel in an X direction from staging/dispensing opening 28 to receive a cup C in space 29 from cup picking system 16 even though carriage 400 as illustrated does not extend into space 29. The X direction is substantially perpendicular to the Y direction and is substantially horizontal. Drive mechanism 406 advantageously maybe a continuous loop drive belt, a linear actuator, or other suitable carriage drive mechanism. Preferably platform 402 is just one part of a carrier 408. Preferably carrier 408 has an open side 410 and an open top 411. Carrier 408 steadies cup C during the filling of cup C with ice and beverage. Platform 402 also has at least one elongated slot 412 and preferably a plurality of parallel slots 412. Between slots 412 are at least one peninsular land 414 which support cup C by its base. Carrier 408 may also have opposed, preferably parallel, sides 416 parallel to slots 412 and a side 418, preferably curved, opposed to open side 410. Side 418 preferably has an opening 420 at the base of side 418 spanning across slots 412. Preferably slots 412 extend longitudinally through opening 420 and through an opposed edge 422 of platform 402. Carrier 408 is configured to allow cup C to be raised off of carrier 408 from below and moved away by a mover as will be discussed later. Any suitable cup transport system and cup carrier can be used according to one aspect of the invention, to move a beverage cup from one desired location to another location.

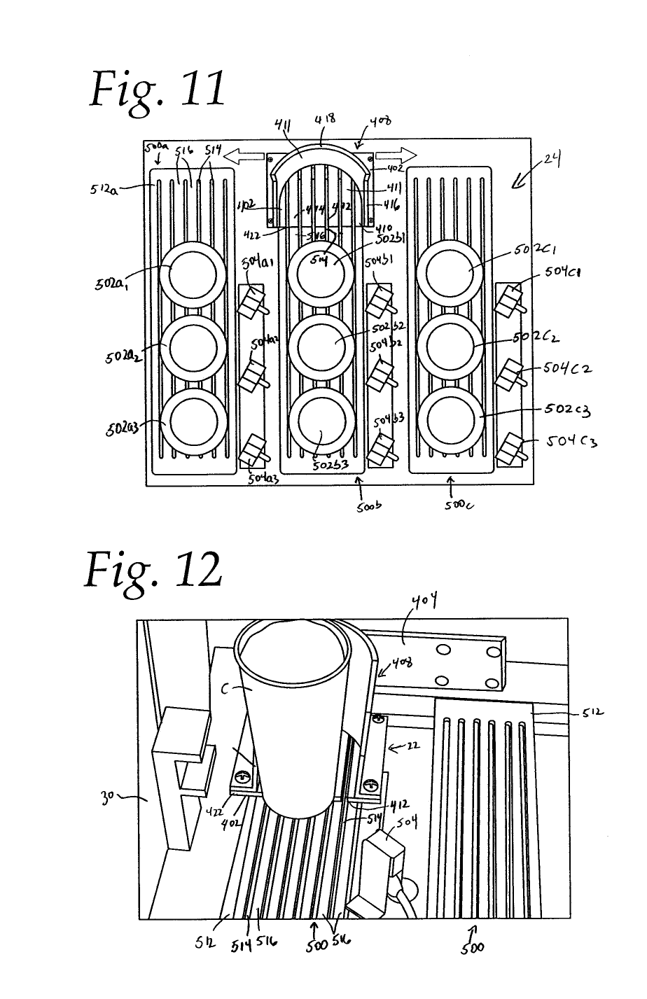

Drink staging system 24 has one or more lanes 500. Each lane 500 can have one or more staging positions 502. Preferably, there are 2 to 4 lanes 500 with 2 to 3 positions 502 each, more preferably there are 3 lanes with 3 positions as shown in FIGS. 1 and 11. Each position 502 can have a sensor 510 for determining whether a cup C is present in position 502. Sensor 510 can be any suitable sensor for detecting the presence of cup C including a proximity sensor (photoelectric for example) or a switch activated by weight or a machine vision system. As illustrated, each position 502 is associated with a post 504 having a green light 506, an amber light 508 and an ultrasound transceiver/sensor 510. Green light 506 indicates that a cup has been detected by transceiver 510. Amber light 508 indicates that transceiver 510 is emitting ultrasound. Sensor 510 communicates with control system 26. Lane 500 has a deck 512 for supporting cups C in positions 502. Deck 512 has slots 514 and peninsular lands 516 between slots 514. Deck 512 may be of any suitable construction including a grate composed of wires or forged as a single piece, for example. Slots 514 and lands 516 are aligned with and preferably of the same width as slots 412 and lands 414 so that platform 402 can be aligned with deck 512 so that slots 412 and 514 are in registry. Preferably, lanes 500 are substantially perpendicular to the direction of movement of carriage 400. Advantageously, lanes 500 extend below platform 402.

In addition, drink-staging system 24 has a cup mover 520 (having a carriage 522, elevator 528 and a platform 521 having elongated raised lands 526) for each lane 500 and a shroud 524 for each carriage 522. As illustrated in FIG. 10, which has one shroud 524 removed for better viewing, platform 521 is carried by carriage 522 which is protected from spills and covered by shroud 524. Carriage 522 permits platform 521 to move along corresponding lane 500 between corresponding staging positions 502 and to platform 402 in the Y direction. Shroud 524 has a slot 530 that allows platform 521 to be outside shroud 524. Raised lands 526 are narrower than slots 514 and 412 and are spaced so that they align with slots 514 and 412. Elevator 528 can raise platform 521 (and lands 526) so that platform 521 raises cup C off of platform 402; carriage 522 can then move cup platform 521 to one of positions 502; and elevator 528 can then lower cup C onto deck 512. Suitable sidewalls, such as sidewall 532 may be provided to enclose various moveable components of staging device 24 as desired. Any suitable type of cup mover can be used in accordance with an aspect of the present invention.

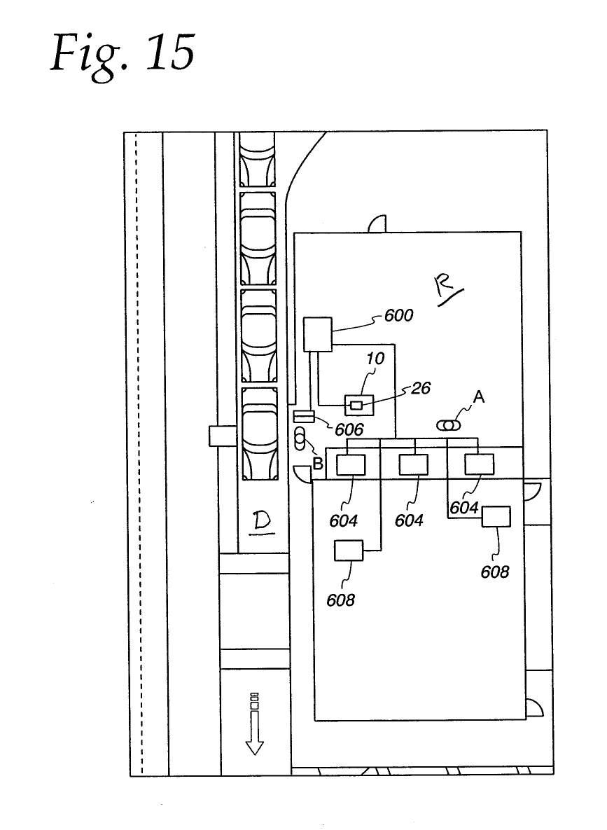

Control system or electronic interface 26 may be connected to an order processor 600 to receive orders for beverages as illustrated in FIG. 15 which shows schematically a quick-service restaurant R having a drive-thru lane D. Processor 600 is in turn connected to point-of-sale (“POS”) device 604 at a front counter, a POS device 606 for drive-thru orders, or even a customer-operated kiosk 608. Devices 604 and 606 typically have a keyboard for entering orders, a human-readable display for viewing orders, a cash drawer, and an electronic payment processor. Devices 604 and 606 may be operated by crew persons or customer attendants A and B, respectively. Processor 600 may also receive orders over the internet from remote locations. Alternatively, control system 26 may be connected directly to POS devices 604 and 606, kiosk 608 and the internet. The connections may occur by any suitable method for transmitting and receiving data including Ethernet, LonWorks and wireless technologies such as Wi-Fi, for example.

In turn, control system 26 is connected to various components of automated beverage device 10 to fulfill beverage orders received, namely, cup-picking system 16, ice storage and dispensing system 18, beverage delivery and dispensing system 20, cup-transport system 22, drink staging system 24 and to a machine vision system.

Control system 26 generally has one or more microprocessors, memory like RAM and ROM, one or more buses, and interfaces for communicating externally with processor 600, for example, or with diagnostic equipment and can be internally located within device 10.

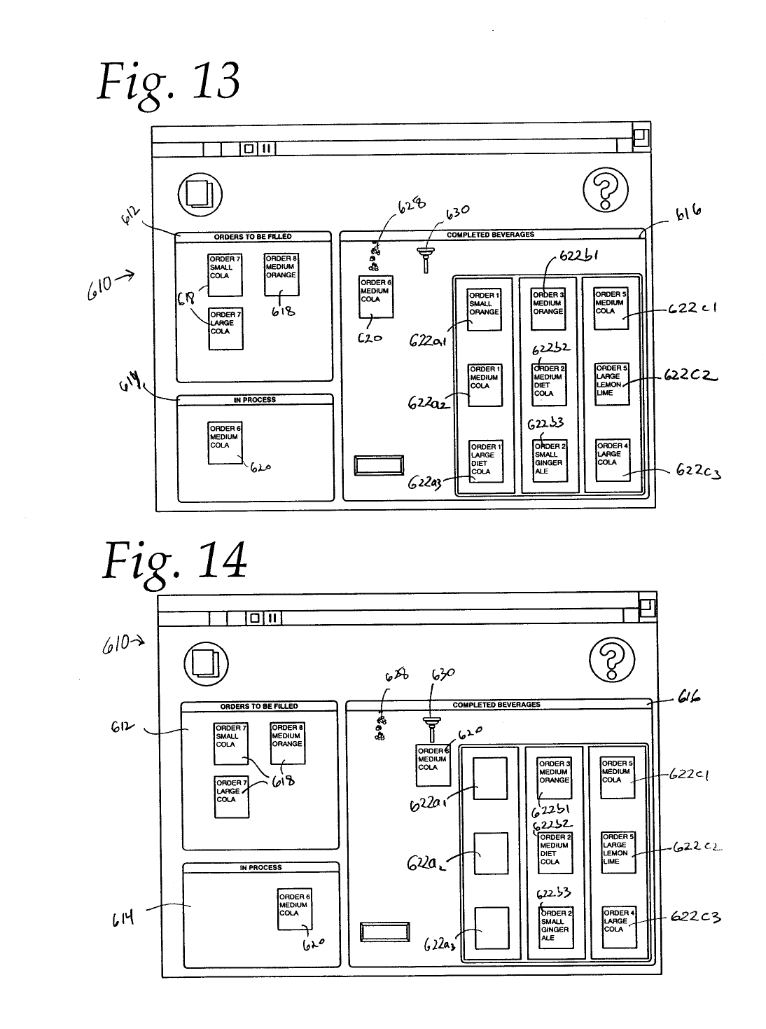

Control system 26 also has a user interface having a screen 610, which is illustrated in FIGS. 13 and 14. Screen 610 can be a touch screen display or alternatively the user interface can have a separate input device like a keypad or touchpad. Screen 610 has a window or area 612 displaying “Orders to be Filled,” a window or area 614 displaying orders “In Process,” a window or area 616 for displaying the location of “Completed Beverages” and the progress of a beverage order in process. Window or areas 612, 614 and 616 display “cards” 618, 620, and 622 representing ordered beverages. Cards as illustrated display on their first line an order number (e.g. “ORDER 1”), on their second line the size of an ordered beverage (e.g., “SMALL,” “MEDIUM” or “LARGE”), and on their third and fourth lines the beverage type (e.g. “COLA,” “DIET COLA,” “ORANGE” or “GINGER ALE”). The cards may include other information as appropriate. Instead of cards, screen 610 may use beverage icons (not shown) to represent the same information as represented by cards. Beverage icons can vary in size to represent different size beverages. Beverage icons can include bubbles to represent carbonated beverages. Beverage icons can vary the color of the icon to represent beverages of different colors. Beverage icons may also be used in conjunction with abbreviations or words like “DIET” and numbers for order numbers to convey information to operators.

References a, b, and c for cards 622 indicate that cards 622 correspond to beverages in lanes 500a, 500b and 500c, respectively. References 1, 2 and 3 for cards 622 indicate that cards 622 correspond to beverage in the first, second and third positions 502 within lane 500. Thus, card 622b1 as shown in FIG. 13 indicates that a medium orange beverage from order 3 is located in position 502b1. Blank card 622a1 in FIG. 14 indicates that there is no beverage staged at position 502a1. Instead of a blank card, no card could be displayed to represent that no beverage is staged at a given position 502.

Icons 628 and 630 represent the filling of cup C with ice by ice dispensing system 18 and filling of cup C with an ordered beverage by beverage dispensing system 20, respectively.

Screen 610 may display errors and warnings. The error and warnings may be shown at the same time at window or areas 612, 614 and 616, instead of one of window or areas 612, 614 and 616, or when areas 612, 614 and 616 are not displayed. Potential errors and warnings could indicate a specific mechanical failure of device 10 or the need to refill supplies like cups, ice or beverage syrup, for example.

Control system 26 may include a machine vision system having a camera 650. The machine vision system may be used to track, verify and guide the movement of cups C through device 10 and the filling of cups C with ice and beverage. Camera 650 may obtain images via visible light, infrared light, or x-rays for example. The machine vision system may use any suitable image processing techniques including thresholding, segmentation, pattern recognition, gauging, and positioning, for example. The machine vision system may be an integral part of the control system or separate in that it may have its own dedicated microprocessor(s) and memory or may share them with the control system as a whole. The machine vision system may be advantageously employed to detect that a cup has been knocked over, for example. If appropriate, device 10 could then redispense a replacement beverage automatically. The machine vision system may also be configured to track cups staged from cup picking head 100, thus having continuous tracking of cups. It would also be able to detect a cup being removed by a person along with a cup being placed by a person manually. It could also detect spilled cups and ice in staging lanes 500a-c. This could be used to provide an audible or visual warning, such as on screen 610, for a person using beverage dispenser 10, as a prompt to clean the lane or activate the raised lands to plow the ice from the lane.

Having set forth various components that can be included in an automated beverage dispenser in accordance with the invention and as disclosed in automated beverage device 10, operation of the automated beverage device 10 will now be discussed. An order is placed at POS device 604, 606 or 608, via the internet or wirelessly from a mobile computing device like a smartphone, for example. The order can include a food order and a beverage order for one or more beverages. The beverage order communicated includes an order number and beverage information. For each beverage ordered, the beverage information includes a beverage type, a beverage size and optionally special instructions such as no ice, added flavors or low fill for a later addition of ice cream as specified by the customer. After this point, the beverage order is processed automatically without human intervention until an operator removes the ordered beverage(s) from device 10 to serve to the customer. The beverage order is communicated typically by processor 600 to control system 26. The beverage order is automatically queued internally by the control system. Depending on how many beverage orders are queued, the beverage order may then be represented by one or more cards 618 or even a card 620.

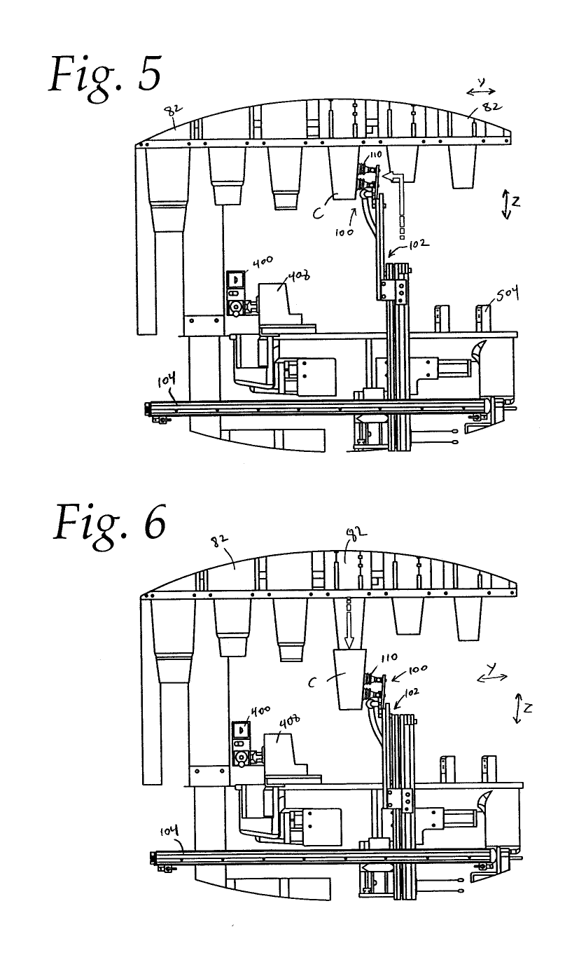

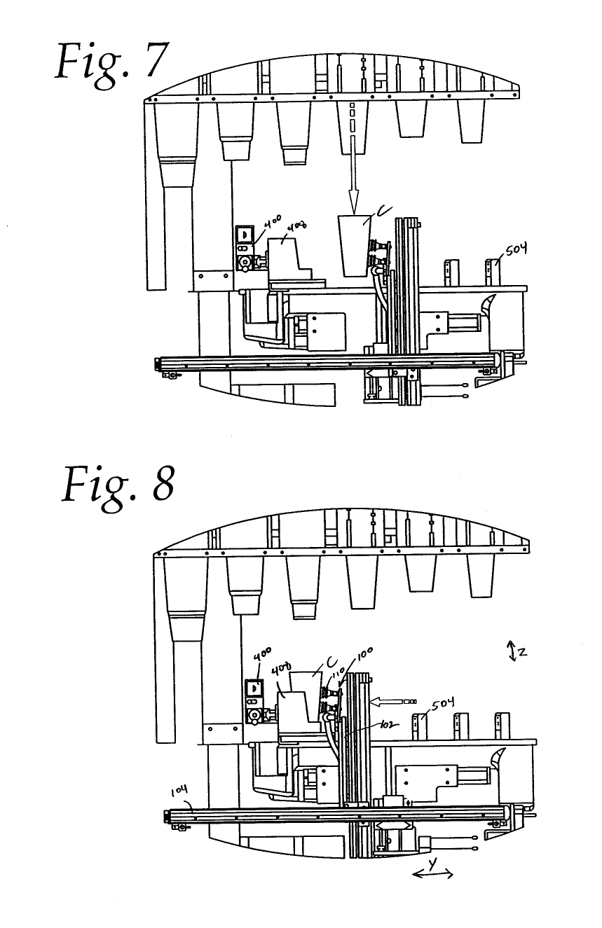

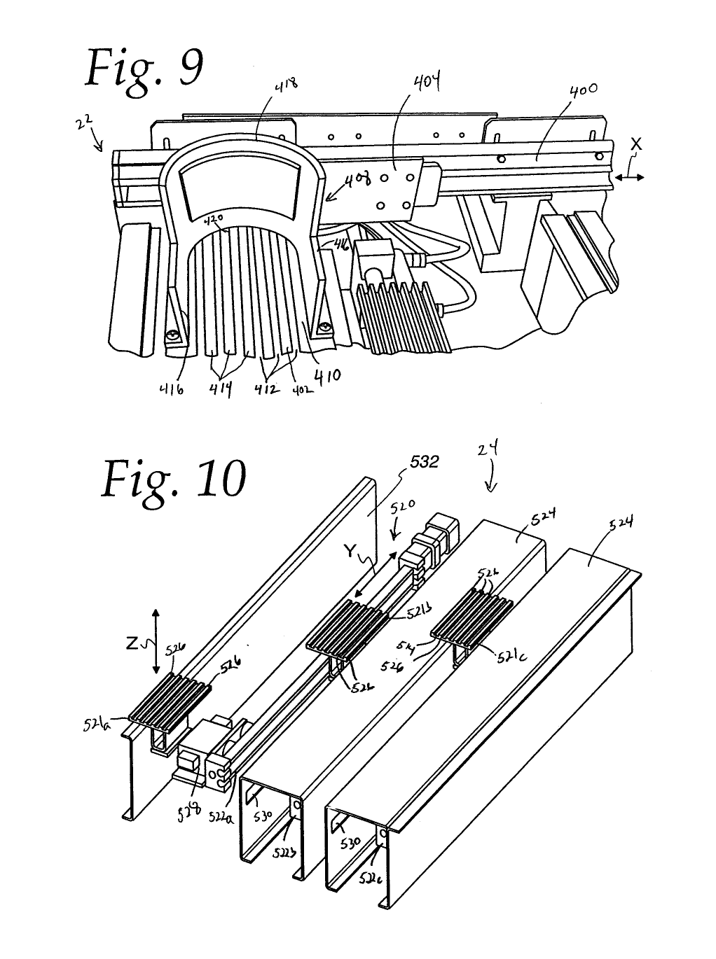

The first step to fulfill a beverage order “in process” is to pick a cup of the appropriate size. Cup-picking system 16 automatically moves cup-picking head 100 in the Y direction so that when mast 102 extends, suction cups 110 are in close proximity and are properly oriented towards the cup to be picked. As illustrated in FIG. 5, the mast 102 then extends and air is sucked through the suction cups by the vacuum source. Next, cup-picking head 100 is automatically moved towards cup C along carriage 104. Suction cups 110 then adhere to cup C under the influence of the vacuum source. The vacuum sensor detects the adherence of suctions cups 110 to cup C by an increase in the vacuum level. As illustrated in FIGS. 6 and 7, mast 102 then automatically retracts extracting cup C from tube 82. As illustrated in FIG. 8, cup C is automatically advanced towards carrier 408, which was previously moved by cup transport system 22 into space 29 and into a cup receiving position. If on the other hand, cup C is to the left of carrier 408 as shown in FIG. 8, cup picking system 16 will move to the right of carrier 408 before carrier 408 is moved by cup transport system 22 to the cup receiving position. Generally, carrier 408 is moved into space 29 after cup C has been removed from tube 82. Once cup C is above carrier 408, automatically the vacuum is released and the cup is dropped onto carrier 408.

If ice is part of the beverage order, carrier 408 automatically then moves the cup below ice nozzle 200 to an ice-receiving position. The ice-receiving position sensor detects the presence of a cup in the ice-receiving position and communicates that information with control system 26. Control system 26 communicates with ice dispensing system 18, which then automatically dispenses an appropriate amount of ice into cup C and screen 610 displays card 620 containing information about the beverage below ice-dispensing icon 628. Next carrier 408 automatically advances cup C to a beverage-receiving position under beverage nozzle 300. Machine vision or a separate sensor detects cup C in the beverage-receiving position. Control system 26 then communicates with beverage dispensing system 20 to automatically dispense the appropriate beverage in the appropriate amount (which would correspond to a medium cola for the situation represented by FIG. 14) to container C and screen 610 displays card 620 below beverage-dispensing icon 630. In an alternative embodiment, ice-dispensing icon 628 can be replaced with icon 630 rather than “moving” card 620 from icon 628 to icon 630 as shown in FIGS. 13 and 14.

The beverage-containing cup is ready to be staged. In one embodiment, automated beverage dispenser 10 can place a lid onto the beverage-containing cup. However, in a preferred embodiment a lid is applied by an operator A or B after the beverage has been staged. Carrier 408 then moves the beverage-containing cup to a transfer position. For each lane 500, there is a transfer position where the slot or slots 412 are aligned with slot or slots 514. In the transfer position, platform 521 is located over deck 512 or alternatively platform 521 could be located beyond the end of deck 512. Control system 26 can determine which transfer position and staging position a cup will head to based on factors including the staging position of other beverages of the same order number and the availability of staging positions. For example, based on the orders represented in FIG. 14, the control system would select staging position 502a3, the most forward of the staging positions in lane 500a, because that position does not block other beverages from being staged in lane 500a.

Once carrier 408 is in the appropriate transfer position, platform 521 is automatically raised by elevator 528 such that lands 526 protrude above slots 412 and thereby raise the cup off of platform 402. Mover 520 then moves the cup away from carrier 408 and towards the staging position 502 selected by the control system. When sensor 510 for the selected staging position 502 detects the cup, automatically elevator 528 lowers platform 521 to place the cup onto deck 512 and screen 610 displays card information about the beverage in the card 622 corresponding to the staging position. Based on FIG. 14, the next card 622 to be displayed would be 622a3 which corresponds to staging position 502a3.

Dispensed beverages can be removed at any time by an operator for service to a customer. To do so, an operator would consult screen 610 to determine the location and identity of beverages for a specific order. For example, an operator looking to remove and serve the beverages for order 1 would consult screen 610 as illustrated in FIG. 13 and determine that the beverages for order 1 are located in staging positions 502a1-502a3. The operator would then remove the three beverages for order 1 while leaving the other staged beverages in place. The operator could indicate to a customer that the beverage from position 502a3 is a diet cola while the beverage from position 502a2 is a regular cola, which is important because the two cola beverages have the same appearance although of different sizes. Sensors 510 would then automatically detect that these three beverages were removed. Control system 26 would then represent this information by blank cards 622a1-622a3 as shown in FIG. 14 on screen 610.

If only some of the beverages within lane 500 are removed by an operator, the remaining beverage(s) in lane 500 block access to the empty positions 502. In one embodiment, device 10 moves the remaining beverages forward, for example, from position 502c2 to 502c3 and from position 502c1 to 502c2. In this embodiment, advantageously platform 521 can be sized to carry two beverages simultaneously. In a separate embodiment, device 10 does not restage beverages relying on an operator to remove and serve the blocking beverage in a timely fashion.

If all staging positions 502 are occupied, device 10 will process the beverage and stage it in carrier 408 until one of staging positions 502 becomes available or an operator takes the beverage from the carrier. The removal of the beverage-containing cup could be detected by an appropriate sensor attached to carrier 408 or by the machine vision system.

When a beverage is removed (by mistake for example) and placed back on carrier 408 or in a staging position 502, control system 26 can respond in various ways. It can assume that the beverage in staging position 502 is the same as the one removed or that the beverage is an unknown beverage. It may with the use of machine vision be able to determine to a limited extent whether the beverage in staging position 502 is the same as the one that was temporarily removed.

User interface may be used to change orders or to indicate spills or empty cups. For example, if a customer changes his or her mind about an ordered beverage, the operator may be able to press onto one of cards 618, 620, or 622 to change or replace the beverage order or to indicate some kind of deficiency with the beverage. Such inputs can be made via menus and other techniques known in the graphical user interface arts.

The invention in one aspect also includes an automated method of dispensing and staging beverages and an automated method of staging beverages. The automated method of dispensing and staging beverages can include providing the automated beverage dispensing device 10 and storing a plurality of cups in the cup storage device. It can include receiving a beverage order from a POS device or other source. Next, one of the plurality of cups from the cup storage device is picked with the cup picker and the picked cup is placed on the cup carrier with the cup picker. Optionally, the cup carrier transports the picked cup to an ice-receiving position where ice is dispensed into the cup by the ice storage and dispensing system. Next the cup carrier transports the picked cup to the beverage dispensing position where an ordered beverage is dispensed into the cup. Generally, then the cup carrier transports the beverage-containing cup to a transfer position. Next, the cup mover moves the beverage-containing cup from the transfer position and along a staging lane having a plurality of staging positions to one of the staging positions. Then the beverage-containing cup is staged at the one staging position.

The automated method of staging beverages can comprise providing at least one staging lane. The at least one lane has a longitudinal direction and a plurality of beverage cup staging positions. Next a beverage cup on a carrier mounted to a carriage is moved to the lane. Then the beverage cup is moved along the lane in the longitudinal direction from the carrier to one of the staging positions. Finally, the beverage cup is staged at the staging position.

While the invention has been described with respect to certain embodiments, as will be appreciated by those skilled in the art, it is to be understood that the invention is capable of numerous changes, modifications and rearrangements, and such changes, modifications and rearrangements are intended to be covered by the following claims.

What is claimed is:

1. An automated beverage dispensing device comprising:
a beverage cup storage device for storing a plurality of beverage cups;
an ice dispensing location and a beverage dispensing location;
a cup picker for picking a beverage cup from the cup storage device;
a cup transport movable along a pathway from a cup receiving position for receiving the beverage cup from the cup picker and for moving a single cup in an upstanding orientation to the ice dispensing location, the beverage dispensing location and then to one or more transfer positions; and
an automated beverage staging device having at least one staging lane, each staging lane associated with one of the transfer positions for staging completed beverages in cups, each staging lane extending generally horizontally away from the associated one of said transfer positions and having a plurality of individual cup staging positions permitting the staging device to stage that plurality of beverages in the staging lane, the at least one staging lane having a beverage cup mover for receiving a beverage cup from the cup transport at the associated one of the transfer positions and for moving the beverage cup to one of the staging positions.

2. The automated beverage dispensing device of claim 1 further comprising an electronic interface including a human-readable display, the electronic interface capable of identifying information on staged beverages and displaying the information on the human-readable display, the information including their staging positions and displaying the information on the display device.

3. The automated beverage dispensing device of claim 2 wherein the electronic interface is capable of indicating when a beverage cup is in the ice dispensing and beverage dispensing positions on the human-readable display and the identity of the beverage to be or being dispensed and the electronic interface device comprises a machine vision device or sensors to obtain information on the location of staged beverages.

4. The automated beverage dispensing device of claim 2 wherein the electronic interface is capable of identifying an order number for each of the staged beverages and displaying that information on the display.

5. The automated beverage dispensing device of claim 2 wherein the electronic interface is capable of identifying the type of beverage to be dispensed and displaying that information on the display.

6. The automated beverage dispensing device of claim 1 wherein the picker comprises at least one suction cup connected to a vacuum source.

7. The automated beverage dispensing device of claim 6 further comprising a vacuum sensor for detecting whether the suction cup has adhered to a beverage cup.

8. The automated beverage dispensing device of claim 1 wherein the cup transport comprises a cup carrier having an open top and an at least partially closed bottom having at least one elongated slot, the elongated slot substantially parallel to the longitudinal direction.

9. The automated beverage dispensing device of claim 1, the staging device comprising three substantially linear staging lanes, each lane capable of staging at least three cups of the type stored in the cup storage device.

10. An automated beverage staging device comprising:
at least one staging lane, the at least one staging lane having a longitudinal direction and a plurality of individual cup staging positions permitting the staging device to stage a plurality of ready-to-serve beverages, each contained in a cup;
a beverage cup carrier mounted to a carriage for moving a beverage cup to the staging lane; and
a cup mover movable along the lane in the longitudinal direction for receiving a beverage cup from the cup carrier and for moving a cup from the cup carrier to one of the staging positions of the staging lane.

11. The automated beverage staging device of claim 10 wherein the cup carrier has an open top and an at least partially closed bottom having at least one elongated slot, the at least one elongated slot at least generally parallel to the longitudinal direction.

12. The automated beverage staging device of claim 11 wherein the cup mover has a mover platform having at least one elongated raised land capable of fitting within the at least one elongated slot.

13. The automated beverage staging device of claim 12 wherein the lane has a lane platform having at least one elongated slot within which the at least one elongated raised land is capable of fitting.

14. The automated beverage staging device of claim 10 further comprising an elevator for raising and lowering the at least one raised land through the top of the at least one slot of the lane and the top of the at least one slot of the cup mover.

15. The automated beverage staging device of claim 10 further comprising a sensor for each of the staging positions for detecting the presence or absence of a beverage cup at the staging position.

16. The automated beverage staging device of claim 10 further comprising an electronic interface including a human-readable display device, the electronic interface capable of identifying information on staged beverages and their staging positions and displaying the information on the display device.

17. The automated beverage staging device of claim 16 wherein the electronic interface comprises a machine vision device to obtain information on the location of staged beverages.

18. An automated method of dispensing and staging beverages comprising:
providing the automated beverage dispensing device of claim 1;
storing a plurality of cups in the cup storage device;
picking one of the plurality of cups from the cup storage device with the cup picker;
placing the picked cup on the cup carrier with the cup picker;
transporting by the cup transport the picked cup to the beverage dispensing position;
dispensing a beverage into the cup in the beverage dispensing position;
transporting by the cup carrier the beverage-containing cup to a transfer position;
moving the beverage-containing cup with the cup mover from the transfer position and along a staging lane having a plurality of staging positions to one of the staging positions; and
staging the beverage-containing cup at the one staging position.

19. The method of claim 18 further comprising staging a second beverage-containing cup at a second staging position.

20. The method of claim 18 further comprising detecting the removal of the beverage-containing cup from the one staging position.

21. The method of claim 20 further comprising staging a second beverage-containing cup to the vacated staging position.

22. The method of claim 18 wherein transporting the beverage-containing cup to a staging position comprises aligning the slot or slots in the cup transport with the slot or slots in the staging lane.

23. The method of claim 22 wherein moving the beverage-containing cup along the lane comprises moving the beverage-containing cup by a cup mover having at least one raised land and lifting the beverage-containing cup off the cup carrier by raising the raised land through at least one slot in the cup carrier.

24. The method of claim 18 further comprising displaying information on the identity of beverages in the plurality of staging positions by the electronic interface on the human-readable display.

25. An automated method of staging beverages comprising:
providing at least one staging lane, the at least one lane having a longitudinal direction and a plurality of beverage cup staging positions;
moving a beverage cup on a carrier mounted to a carriage to the lane; and
moving the beverage cup along the lane in the longitudinal direction from the carrier to one of the staging positions; and
staging the beverage cup at the staging position.

26. The method of claim 25 further comprising staging a second beverage cup at a second staging position.

27. The method of claim 25 further comprising detecting the removal of the beverage cup from the one staging position.

28. The method of claim 27 further comprising staging a second beverage cup at the vacated staging position.

29. The method of claim 25 wherein moving the beverage cup on the carrier comprises aligning at least one slot in the carrier with at least one slot in the lane.

30. The method of claim 29 wherein moving the beverage cup along the lane comprises moving the beverage cup by a beverage cup mover having at least one raised land and lifting the beverage cup off the beverage cup carrier by raising the raised land through the slot in the beverage cup carrier.

31. The method of claim 25 further comprising displaying information on the identity of beverages in the plurality of staging positions with an electronic interface on a human-readable display.

32. A beverage cup carrier comprising an open top and an at least partially closed bottom having at least one elongated slot.

33. The beverage cup carrier of claim 32 further comprising an open side, the at least one elongated slot extending to the open side.

34. The beverage cup carrier of claim 33 further comprising a side opposite the open side, the side having an opening at its base, the opening spanning across the at least one elongated slot.

35. The beverage cup carrier of claim 33 further comprising third and fourth sides substantially parallel to the at least one elongated slot.

36. The beverage cup carrier of claim 32 wherein the at least one elongated slot comprises a plurality of substantially parallel elongated slots.

37. A beverage cup moving device comprising:
a carriage; and
a beverage cup carrier comprising an open top and an at least partially closed bottom having at least one elongated slot; the carrier mounted to the carriage.

38. The beverage cup moving device of claim 37 wherein the carrier further comprises an open side, the at least one elongated slot extending to the open side.

39. The beverage cup moving device of claim 38 wherein the carrier further comprises a side opposite the open side, the side having an opening at its base, the opening spanning across the at least one elongated slot.

40. The beverage cup moving device of claim 38 wherein the carrier further comprises third and fourth sides substantially parallel to the at least one elongated slot.

41. The beverage cup moving device of claim 38 wherein the at least one elongated slot comprises a plurality of substantially parallel elongated slots.

42. A method of moving a beverage cup containing a beverage comprising:
providing a beverage cup carrier comprising an open top and an at least partially closed bottom having at least one elongated slot;
moving a beverage cup containing a beverage in the cup carrier; and
moving at least one elongated land through the elongated slot to lift the beverage cup form the beverage cup carrier.
